(19) United States
(12) Patent Application Publication
(10) Pub. No.: US 2015/0294752 A1
(43) Pub. Date: Oct. 15, 2015

(54) GRAPHENE MASTERBATCH

(71) Applicant: Enerage Inc., Wujie Township (TW)

(72) Inventors: Mark Y. Wu, Wujie Township (TW); Cheng-Yu Hsieh, Wujie Township (TW); Jing-Ru Chen, Wujie Township (TW); Shu-Ling Hsieh, Wujie Township (TW)

(21) Appl. No.: 14/594,662

(22) Filed: Jan. 12, 2015

(30) Foreign Application Priority Data
Apr. 15, 2014 (TW) 103113686

(51) Int. Cl. H01B 1/24

(52) U.S. Cl. CPC H01B 1/24

(57) ABSTRACT

Disclosed is a graphene masterbatch including a base resin, electrically conductive carbon black, graphene nanoplatelets with modified surface and a dispersant. The modified surface of graphene nanoplatelet is formed by a modifying agent containing a coupling compound so as to possess hydrophobic and hydrophilic functional groups, which help graphene nanoplatelets form chemical bonding with carbon black and the base resin. Since the modified surface makes graphene nanoplatelets evenly dispersed in the base resin, the graphene masterbatch of the present invention is suitably melt blended with a polymer material to form a composite material such that graphene nanoplatelets are evenly dispersed in the polymer material, thereby enhancing junction strength, increasing mechanical properties, and improving anti-oxidation, acid/base resistance, and thermal conductivity.

### CROSS-REFERENCE TO RELATED APPLICATION

This application claims the priority of Taiwanese patent application No. 103113686, filed on Apr. 15, 2014, which is incorporated herewith by reference.

### BACKGROUND OF THE INVENTION

1. Field of the Invention

The present invention generally relates to a graphene masterbatch, and more specifically to a graphene masterbatch comprising surface-modified graphene nanoplatelets having improved compatibility with carbon black and polymer material so as to achieve homogeneous mixing and greatly enhance the cohesive strength of the junction.

2. The Prior Arts

It has been well known that graphene has a hexagonal honeycomb structure formed of two-dimensional crystal bonded by sp² hybrid orbital. In particular, the thickness of graphene is only 0.335 nm, about one carbon diameter such that graphene is the thinnest and hardest material in the world. More specifically, graphene also has excellent electrical and thermal conductive properties. Its mechanical strength is larger than steel by one hundred times more, and its specific gravity s only one fourth of steel. Therefore, graphene is certainly one of the best options to enhance the current composite materials.

However, graphene tends to aggregate and lump together due to intrinsic nature. It has been one of the crucial technical issues for practical applications to obtain graphene powder with high homogeneity and less stacked layers so as to avoid irregularly stacking up.

Polymer materials have been widely used in various application fields. As advanced progresses in technologies, the requirements for the material become much stricter. For now, most of the traditional polymer materials do not meet the critical requirements specified by general industries and high tech industries, including the properties of mechanical strength, chemical resistance, weather endurance, electrical conductivity and thermal conductivity. For Nylon, one of the popular engineering polymers, its mechanical strength, abrasion resistance and heat endurance are excellent, but its application field is still greatly limited because of high humid absorption, poor acid resistance and being easily oxidized.

In the prior arts, to improve the performance of the polymer, it is common to combine the polymer and the nanometer material to form a composite material, which is much lighter and easily processed, and has improved mechanical strength like impact resistance. Thus, the composite material has been widely used in the current industries such as automobile, aerospace vehicle, information, medicine, and so on. Moreover, some new properties are successfully developed and prepared to meet the requirements for the actual applications in the upcoming future.

CN 103073930A disclosed a composite material formed of alkylated functional graphene and Nylon 66 (PA66). Specifically, graphene oxide prepared by an improved Hummers method is dispersed into a mixed solution formed of a micromolecular ketone compound and water, the process of ultrasonic vibration for exfoliation is performed, and then the resulting solution is centrifuged and dried so as to form alkylated functional graphene. Subsequently, alkylated functional graphene and PA66 served as raw materials are processed by a melt blending treatment to obtain a graphene/PA66 nanocomposite. While the obtained nanocomposite material is superior to the raw PA66 in mechanical performance and decomposition temperature, functional graphene has to be added when the polymer is polymerized. As a result, this method is strictly limited in the manufacturing process, and disadvantageous for industrial use.

Additionally, WO 2012/151433A2 disclosed a nanocomposite which comprises a base polymer including polyethylene terephthalate (PET) and a nanoparticulate substrate like graphene. The nanocomposite material is obtained by the steps of mixing the base polymer and the nanoparticulate substrate acquired through exfoliation to form a masterbatch product, and injection or blow molding the masterbatch product. The mechanical strength is thus enhanced for PET. However, one shortcoming is that graphene acquired through exfoliation has fewer function groups on the surface such that it fails to form an effective junction with the polymer resin. Even if the raw masterbatch is previously formed, the dispersion and the junction property of the graphene powder and the base polymer are still not effectively improved.

US 2012/0241686A1 titled by “CARBON NANOTUBE MASTERBATCH, PREPARATION THEREOF, AND USE IN FORMING ELECTRICALLY CONDUCTIVE THERMOPLASTIC COMPOSITION”, a masterbatch by mixing carbon nanotubes and wax is prepared, and then an electrically conductive thermal plastic composition is obtained by melt blending a polymer and the masterbatch. The primary aspect of this patent is that the masterbatch formed of carbon nanotubes improves the melt fluidity of the electrically conductive thermoplastic composition such that it is easily processed in subsequent treatments. One drawback is that the surface of carbon nanotube is not modified, and it is difficult for carbon nanotubes to homogeneously disperse in wax, thereby the excellent performance of carbon nanotubes failing to fully demonstrate.

For another patent US 2013/0214211A1, conductive carbon material is added into thermoplastic or thermosetting material to obtain an electrical conductive masterbatch, which can eliminate electrostatic charge in the subsequent process to implement the effect of antistatic. The risk during the manufacturing and processing treatment is thus greatly reduced. This patent uses carbon black, carbon fiber, graphene and carbon nanotube as the electrically conductive material. However, without any wetting agent and the modified surface, the effect of antistatic is greatly limited in actual application due to poor homogeneity of the electrically conductive material whenever the thermoplastic or thermosetting plastic is directly added or the masterbatched is previously prepared.

Therefore, it is greatly needed to provide a new graphene masterbatch using the functional groups on the modified surface of the graphene to increase the compatibility with the function groups of the resin so as to enhance the junction strength and effectively improve the mechanical performance of the composite material, thereby overcoming the problems in the prior arts.

### SUMMARY OF THE INVENTION

The primary objective of the present invention is to provide a graphene masterbatch for melt blending a polymer material to form a modified polymer matrix as a composite base material. Generally, the graphene masterbatch of the present invention may comprise about 1-20 wt % of a base resin, about 20-40 wt % of electrically conductive carbon black, about 20-50 wt % of graphene nanoplatelets with modified surface and about 1-15 wt % of a dispersant.

Specifically, the base resin is a base material for masterbatch, and may comprise at least one of polyolefin, polyester, polycarbonate (PC), polyurethane (PU) and acrylonitrile-butadiene-styrene copolymer (ABS). The electrically conductive carbon black is electrically conductive. In addition, the dispersant functions the effect of homogeneously dispersing the graphene nanoplatelets without aggregation, and preferably comprises at least one of polyethylene wax, stearamide, polyamide wax, paraffin oil, polypropylene wax, polyethylene wax, vinyl acetate wax, paraffin wax, polyethyleneglycol adipate, calcium stearate, zinc stearate and polymethylmethacrylate.

In particular, the graphene nanoplatelet has a modified surface layer, which is formed by covering the surface of the graphene nanoplatelet with a modifying compound including a coupling agent. More specifically, the coupling agent contains hydrophilic and hydrophobic functional groups used to activate chemical reaction so as to form chemical bonds with the carbon black and the base resin.

The surface modified layer helps the graphene nanoplatelets being well dispersed in the base resin such that when the graphene masterbatch of the present invention is melt blended with the polymer material to form the composite base material, the grapheme nanoplatelets are homogeneously dispersed in the polymer base material. As a result, the strength of junction cohesion is increased, and the mechanical strength, anti-oxidation, acid resistance, electrical conductivity and thermal conductivity of the whole composite base material are also enhanced.

### DETAILED DESCRIPTION OF THE PREFERRED EMBODIMENT

The present invention may be embodied in various forms and the details of the preferred embodiments of the present invention will be described in the subsequent content.

The present invention provides a graphene masterbatch for melt blending a polymer material to form a modified polymer matrix as a composite base material. The graphene masterbatch of the present invention generally comprises about 1-20 wt % (weight percent) of a base resin, about 20-40 wt % of electrically conductive carbon black, about 20-50 wt % of graphene nanoplatelets with modified surface and about 1-15 wt % of a dispersant.

The base resin serves as a base material for the grapheme masterbatch, and commonly comprises at least one of polyolefin, polyester, polycarbonate (PC), polyurethane (PU) and acrylonitrile-butadiene-styrene copolymer (ABS). In particular, low density polyethylene (LDPE) is preferably selected as polyolefin.

Additionally, the electrically conductive carbon black is electrically conductive, and has an average particle size less than 1 μm, and a specific surface area larger than 60 m²/g. Here, the primary purpose of adding carbon black is to increase the carbon content in the composite material so as to improve the whole performance of the composite material used in the final product. The reason is that graphene nanoplatelet is a nanometer material with high specific surface area and huge volume, and its tap density is thus relatively low such that the allowable concentration of the graphene nanoplatelet in the masterbatch is quite limited, and fortunately the carbon black can solve this problem. Another advantage of carbon black is that graphene is substantially formed of a two dimensional planar structure, and carbon black is an intrinsic particle having a three dimensional structure such that effective network is formed in the plastic base material by mixing and blending carbon black and graphene nanoplatelets, thereby achieving excellent performance at a lower content of the additives.

Specifically, the dispersant is used to homogeneously disperse the graphene nanoplatelets without aggregation. The dispersant is preferably selected from a group consisting of at least one of polyethylene wax, stearamide, polyamide wax, paraffin oil, polypropylene wax, polyethylene wax, vinyl acetate wax, paraffin polyethyleneglycol adipate, calcium stearate, zinc stearate and polymethylmethacrylate.

The graphene nanoplatelets according to the present invention comprises N graphene layers stacked together, where N is an integer with a range between 30 and 300. It is preferred that the tap density of the graphene nanoplatelet is within a range between 0.1 g/cm³ and 0.01 g/cm³, the thickness is within a range between 10 nm and 100 nm, the planar lateral size is within a range between 1 μm and 100 μm, and the ratio of the planar lateral size to the thickness is within a range between 10 and 1000.

Furthermore, the above graphene nanoplatelet substantially has a modified surface layer, which is generally formed by covering the surface of the graphene platelet with a surface modifying compound including a coupling agent. The coupling agent may contain hydrophilic and hydrophobic functional groups used to form chemical bonds with the electrically conductive carbon black and the base resin by chemical reaction. As a result, the compatibility is greatly improved. More specifically, the coupling agent is specified by a chemical formula Mₓ(R)_{y}(R′)_{z}, where M is a metal element, R is a hydrophilic functional group, R′ is a hydrophobic functional group, and x, y and z are positive integers, preferably, 0≦x≦6, 1≦y≦20, and 1≦z≦20.

The above hydrophilic functional group R is selected from a group consisting of at least one of alkoxy, carbonyl, hydroxyl, acyloxy, alkyleneoxy and alkyleneoxyhydroxyl, the metal element M is selected from a group consisting of at least one of aluminum, titanium zirconium and silicon, and the hydrophobic functional group R′ is selected from a group consisting of at least one of vinyl, fatty alkylene oxide group, styryl, methacrylicoxyl, acrylicoxyl, fatty amino, propyl chloride group, fatty thiohydroxy, fatty sulfido group, socyanato group, fatty urea group, fatty carboxyl, fatty hydroxylic, cyclohexyl, benzyl, fatty formyl, fatty acetyl, benzoyl vinyl and fatty alkylene oxide group.

Moreover, the oxygen content of the graphene nanoplatelet preferably within a range between 3-20 wt %.

To further explain the aspect of the graphene masterbatch according to the present invention, some illustrative examples described below are use to help those skilled in this technical field better understand all the processes and the functions achieved.

### ILLUSTRATIVE EXAMPLE 1

Here, 3-Aminopropyl triethoxysilane having a structural formula like Si(C₃H₆N)(C₂H₅O)₃ is selected as the surface modifying agent. First, the surface modifying agent is added into a solution formed of ethanol and water, and then the graphene nanoplatelets are mixed and stirred in the solution with ultrasonic vibration. Finally, the solution is filtered by suction using the air pump obtain the wet powder, and the wet powder is dried in the oven, resulting in the graphene nanoplatelets with modified surface. Specifically, the graphene nanoplatelets are manufactured by the traditional oxidation-reduction method, and the surface thereof contains a carbon-oxygen or carbon-hydrogen functional group, which is used to react with siloxane so as to modify the surface of the graphene nanoplatelet.

### ILLUSTRATIVE EXAMPLE 2

The recipe includes 20% of PC/ABS mixed base resin, 40% of electrically conductive carbon black, 25% of graphene nanoplatelets with modified surface and 15% of polymethylmethacrylate. First, according to the above recipe, the PC/ABS mixed base resin, carbon black, graphene nanoplatelets and polymethylmethacrylate are pre-mixed, the mixture is then placed into a high speed mixer to perform high speed mixing. The resultant mixture is placed into a banbury mixer to perform a banbury treatment at 180° C. for 10 minutes so as to acquire a composite material. Next, the composite material is smashed, extruded through a two screws extruder, and hot cut and cooled down in water. Finally, the resultant material is dried to form the graphene masterbatch as desired.

### ILLUSTRATIVE EXAMPLE 3

The present recipe includes 15% of linear LDPE, 40% of electrically conductive carbon black, 30% of graphene nanoplatelets with modified surface and 15% of polyethylene wax. First, the above recipe is pre-mixed, and the mixture is placed into the high speed mixer to perform a medium speed mixing. Then, the resultant mixture is poured into the banbury mixer to perform the banbury treatment at 150° C. for 10 minutes so as to acquire the composite material. The composite material is smashed and dropped into the two screws extruder to extrude. The extrude composite material hot cut and cooled down in water. Finally, the resultant material is dried to obtain the graphene masterbatch.

From the above-mentioned, one aspect of the present invention is that the hydrophilic and hydrophobic functional groups of the modified surface of the graphene nanoplatelet is used to combine with the electrically conductive carbon black and the base resin by forming chemical bond through chemical reaction. As a result, the compatibility is greatly enhanced, and the cohesion strength of the junction is improved. At the same time, owing to the modified surface layer of the graphene nanoplatelet being able to help graphene nanoplatelet homogeneously dispersed in the base resin, when the graphene masterbatch of the present invention is melt blended with the plastic material to form the composite base material, the graphene nanoplatelet can be effectively and homogeneously dispersed in the base material, thereby increasing the junction cohesion, improving the mechanical property, anti-oxidation, acid resistance, electrical conductivity and thermal conductivity of the whole composite base material.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A graphene masterbatch, comprising:
1-20 wt % (weight percent of the graphene masterbatch) of a base resin;
20-40 wt % of electrically conductive carbon black;
20-50 wt % of graphene nanoplatelets; and
1-15 wt % of a dispersant,
wherein each of the graphene nanoplatelets has a modified surface layer, the modified surface layer is formed by covering a surface of the graphene nanoplatelet with a surface modifying compound comprising a coupling agent, the coupling agent is specified by a chemical formula Mₓ(R)_{y}(R′)_{z}, M is a metal element, R is a hydrophilic functional group, R′ is a hydrophobic functional group, x, y and z are positive integers, and 0≦x≦6, 1≦y≦20, and 1≦z≦20,
wherein the graphene nanoplatelet has an oxygen content within a range between 3-20 wt %, and
wherein the hydrophilic and hydrophobic functional groups are used to chemically react with the electrically conductive carbon black and the base resin to form chemical bond.

2. The graphene masterbatch as claimed in claim 1, wherein the base resin serves as a base material for the grapheme masterbatch, and comprises at least one of polyolefin, polyester, polycarbonate (PC), polyurethane (PU) and acrylonitrile-butadiene-styrene copolymer (ABS).

3. The graphene masterbatch as claimed in claim 2, wherein low density polyethylene (LDPE) is selected as the polyolefin.

4. The graphene masterbatch as claimed in claim 1, wherein the electrically conductive carbon black has an average particle size less than 1 μm, and a specific surface area larger than 60 m²/g.

5. The graphene masterbatch as claimed in claim 1, wherein the dispersant is preferably selected from a group consisting of at least one of polyethylene wax, stearamide, polyamide wax, paraffin oil, polypropylene wax, polyethylene wax, vinyl acetate wax, paraffin wax, polyethyleneglycol adipate, calcium stearate, zinc stearate and polymethylmethacrylate.

6. The graphene masterbatch as claimed in claim 1, wherein the hydrophilic functional group R is selected from a group consisting of at least one of alkoxy, carbonyl, hydroxyl, acyloxy, alkyleneoxy and alkyleneoxyhydroxyl, the metal element M is selected from a group consisting of at least one of aluminum, titanium zirconium and silicon, and the hydrophobic functional group R′ is selected from a group consisting of at least one of vinyl, fatty alkylene oxide group, styryl, methacrylicoxyl, acrylicoxyl, fatty amino, propyl chloride group, fatty thiohydroxy, fatty sulfido group, socyanato group, fatty urea group, fatty carboxyl, fatty hydroxylic, cyclohexyl, benzyl, fatty formyl, fatty acetyl, benzoyl vinyl and fatty alkylene oxide group.

7. The graphene masterbatch as claimed in claim 1, wherein the graphene nanoplatelets comprises N graphene layers stacked together, N is an integer with a range between 30 and 300, a tap density of the graphene nanoplatelet is within a range between 0.1 g/cm³ and 0.01 g/cm³, a thickness of the graphene nanoplatelet is within a range between 10 nm and 100 nm, a planar lateral size of the graphene nanoplatelet is within a range between 1 μm and 100 μm, and a ratio of the planar lateral size to the thickness is within a range between 10 and 1000.
